(19) United States
(12) Patent Application Publication
(10) Pub. No.: US 2002/0122926 A1
(43) Pub. Date: Sep. 5, 2002

(54) Laminated article and method of making same

(76) Inventor: Raymond L. Goodson, Sandy, UT (US)

Correspondence Address: Mark L. Davis, P.O. Box 9293, Gray, TN, 37615-9293, US

(21) Appl. No.: 10/086,269

(22) Filed: Mar. 1, 2002

Related U.S. Application Data
(60) Provisional application No. 60/273,076, filed on Mar. 5, 2001.

(51) Int. Cl. B32B 1/00; D03D 15/00; B32B 27/12

(52) U.S. Cl. 428/220; 428/903; 442/190; 442/286; 442/287; 442/364; 442/394; 442/395; 156/311

(57) ABSTRACT

A thermoplastic laminate article has a first thermoplastic layer selected from polyester and polycarbonate with first and second surfaces, a second thermoplastic layer selected from polyethylene and polypropylene has a third surface disposed toward the first surface, and a bonding agent is disposed between the first and third surfaces. In preparing the thermoplastic laminate article, the bonding agent is coated onto at least one of the first or third surfaces, the layers are then placed in a superposed relationship and thereafter sufficient heat and pressure are applied to the second surface and an outer surface of the second thermoplastic layer to cause the bonding agent to flow and spread between the first and third surfaces to form a bond between the first thermoplastic layer and the second thermoplastic layer.

### CROSS REFERENCE TO RELATED APPLICATIONS

Benefit is claimed to the earlier filed application having U.S. Ser. No. 60/273,076 filed Mar. 5, 2001 the entire disclosure of which is incorporated herein by reference.

### BACKGROUND OF THE INVENTION

1. Field of the Invention

The present invention relates to a thermoplastic laminate article wherein dissimilar materials are bonded together sufficiently to resist delamination. More particularly, the thermoplastic laminate article includes a substrate layer, a top layer, and a bonding agent disposed between the substrate layer and the top layer. Another aspect of the present invention is a method for making the thermoplastic laminate article.

2. Background of the Invention

Laminated articles and material composites are well known and widely accepted for a variety of end uses. For example, plywood which is a laminated layered construction, is used extensively in the building industry. Paper and plastic laminates are used for the storage of food and beverages, and are used in photographic applications. Metal and plastic laminates are used in the electronics industry. An advantage of using a laminate is that generally, there is an improvement in one or more properties of the laminate as compared to the individual components used in constructing the laminate. As used herein “laminate” or “laminated” describes an article having at least two layers wherein, desirably, at least one layer is superimposed over at least a portion of the other layer and the layers are easily identifiable; whereas “composite” as used herein describes an article having a resin matrix substantially encapsulating a reinforcing fiber(s) such as, for example, glass, carbon, mica, or other material.

However, in some cases certain materials which offer the prospect of providing improved properties in a laminate structure do not readily adhere to the adjacent layers. The end result is unequal lamination and/or delamination during milling, cutting or thermoforming or after a period of use, which adversely affects the functional or aesthetic characteristics of the resulting product. One contributing factor for unequal lamination and/or delamination is unequal adhesive add-on or surface coverage between the two adjacent surfaces. Another contributing factor involves non-compatible surfaces wherein one surface has a low surface energy. As used herein, “low surface energy” means having a surface energy, as is understood by those skilled in the adhesive art, of less than about 40 mJ/m².

U.S. Pat. No. 5,894,048 discloses a synthetic laminate structure having an outer layer of transparent copolyester, a printed or colored film layer having opposed surfaces wherein at least one of the surfaces is colored or has an image printed thereon, and a backing layer. A polyurethane-based bonding agent is provided between the outer layer and film layer and preferably between the film layer and backing layer which, upon cooling, forms an adhesive.

U.S. Pat. No. 5,998,028 discloses a laminate structure having metallic wire, rods or bars sandwiched between two layers of a copolyester. The laminate is formed by heating the upper and lower copolyester layers to a sufficient temperature and pressure to bond the two layers together.

U.S. Pat. No. 6,025,069 discloses a thermoplastic article having a high-relief, molded or embossed surface obtained by contacting a laminate comprising first and second copolyester sheet materials with a suitable mold with heat and pressure to simultaneously bond the sheet materials together and produce a decorative texture or design on the surface of at least one of the sheets.

U.S. Pat. No. 5,958,539 discloses a laminate having, in order, (1) an upper sheet material, (2) a fabric comprised of textile fibers, and (3) a lower sheet material. The upper and lower sheet materials are produced from certain copolyesters containing repeating units of terephthalic acid residues, ethylene glycol residues and cyclohexanedimethanol residues.

Although the aforementioned patents provide for a laminate structure that is suitable for use as, for example, counter tops, table tops, cabinet doors, game boards, children's toys, panels for shower stalls, hot tubs, chalkboards, indoor and outdoor signs, and seamless vanity tops, there remains a need for a laminate structure wherein dissimilar materials are bonded together without applying a sufficiently compatible overlying sheet or film layer.

### SUMMARY OF THE INVENTION

Briefly, the present invention relates to thermoplastic laminate article wherein at least two layers of dissimilar material are bonded together sufficiently to resist delamination. The thermoplastic laminate article includes: a substrate or first thermoplastic layer; a second thermoplastic layer superposed over at least a portion of the first thermoplastic layer; and a bonding agent disposed between the first and second thermoplastic layers.

Another aspect of the present invention is a method for making the thermoplastic laminate article. The method includes the steps of coating a bonding agent on a surface of at least one of the first or second thermoplastic layers, placing the layers in a superposed relationship over the at least one coated surface, and applying sufficient heat and pressure to the layered configuration to cause the bonding agent to form a substantially continuous layer and form a bond between the substrate layer and the outer layer.

It is an object of the present invention to provide a thermoplastic laminate article, such as a sheet good, counter top, table top, cabinet door, game board, children's toy, panel for shower stalls, hot tubs, chalkboards, indoor and outdoor sign, and seamless vanity tops, wherein dissimilar materials are bonded together without applying a sufficiently compatible overlying sheet or film layer.

Another object of the present invention to provide a laminate article wherein dissimilar materials are sufficiently bonded together without applying a overlying sheet, film or mesh of a sufficiently compatible material to capture or encapsulate at least one of the dissimilar materials.

It is another object of the present invention is to provide a laminate article wherein a polyolefinic material is bonded to at least one surface of a thermoplastic substrate and the polyolefinic material is exposed allowing a person to touch the polyolefinic material.

An additional object of this invention is to provide a thermoplastic laminate article and a method of making thermoplastic laminate articles wherein layers of material heretofore difficult to laminate are effectively and uniformly laminated together to minimize delamination providing a product with improved functional and aesthetic properties.

Another object of the present invention is to provide a thermoplastic laminate article having a raised or textured surface.

These and other objects and advantages of the present invention will become more apparent to those skilled in the art in view of the following description and the accompanying drawings wherein like parts and objects have similar reference numerals. It is to be understood that the inventive concept is not to be considered limited to the constructions disclosed herein but instead by the scope of the appended claims.

### BRIEF DESCRIPTION OF THE DRAWINGS

FIG. 1 is a cross-sectional view of a one embodiment of the laminate article of the present invention wherein a top layer is superposed over one of the surfaces of the substrate layer.

FIG. 2 is a cross-sectional view of another embodiment of the laminate article of the present invention wherein a top layer is superposed over both of the surfaces of the substrate layer.

FIG. 3 is a cross-sectional view of the various layers during the preparation of the laminated article of FIG. 1.

### DETAILED DESCRIPTION OF THE INVENTION

For ease of description, the laminated article is illustrated and described in the form of a sheet material, but the invention described herein is not limited to sheeting materials. One skilled in the art will appreciate that the thermoplastic laminate article is capable of being thermoformed into a variety of useful articles and shapes.

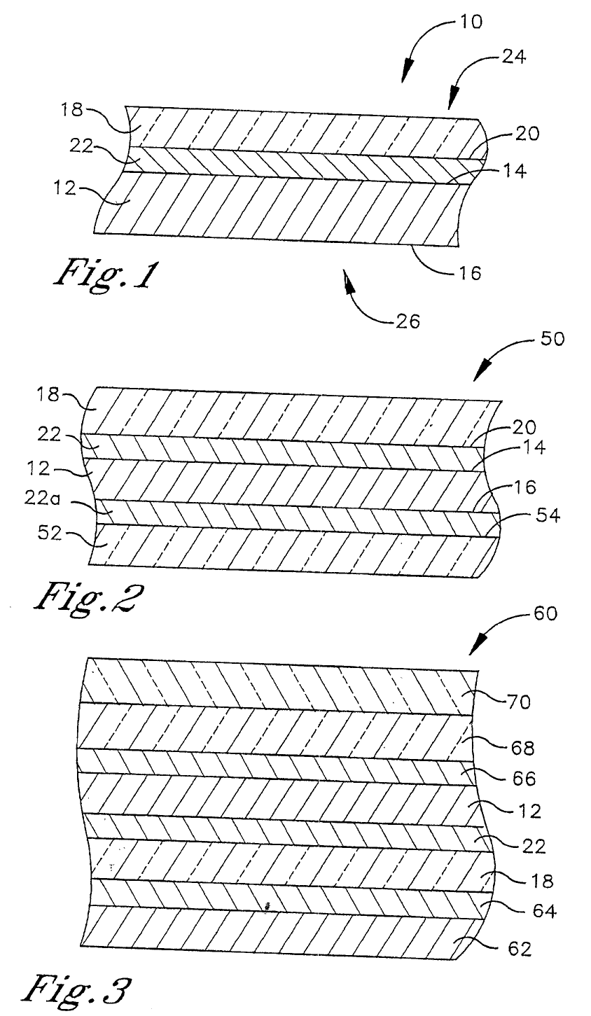

Referring to FIG. 1, a laminated article 10 is illustrated having a first thermoplastic layer 12 with a first surface 14 and second surface 16. Positioned proximate to the first surface 14 is a second thermoplastic layer 18. The second thermoplastic layer includes a third surface 20 juxtaposed to at least one of the first or second surfaces, 14 or 16, and preferably resides adjacent to the first surface 14. Disposed between the first surface 14 and the third surface 20 is a bonding agent 22 for securing the first thermoplastic layer and second thermoplastic layer together.

The first thermoplastic layer 12 is a material selected from a polyester or polycarbonate and preferably is a polyester. The first thermoplastic layer 12 should exhibit good impact resistance, strength, and desirably is resistant to abrasion. The thickness of the first thermoplastic layer 12 is not critical and is limited only by functionality. Generally, the first thermoplastic layer 12 is from about 0.005 to about 1 inch (0.127 mm to about 25.4 mm) in thickness. Desirably, the first thermoplastic layer 12 is a polyester of polyethylene terephthalate modified with 2 mole % to 99 mole % of cyclohexanedimethanol repeat unit. The cyclohexanedimethanol may be either the 1,4- or 1,3-isomer and may be either in the cis- or trans- form or a mixture of the isomers. The copolyester may be semi-crystalline or amorphous, and preferably is amorphous. Such polyester are known compositions of matter and are available from Eastman Chemical Company, Kingsport, Tenn., under the trade name of PETG.

These copolyesters generally are amorphous of exhibit a low level of crystallinity and have repeating units of diacid and diol residues. At least 80 mole percent of the diacid residues are terephthalic acid residues. As used herein “residue” refers to that portion of the diacid or diol which constitutes a portion of the diester and which constitutes repeating units within a portion of the polyester. The diacid component of the copolyesters optionally may comprise up to 20 mole percent of one or more other dicarboxylic acid such that the sum of the dicarboxylic acid units is equal to 100 mol percent. Examples of such other dicarboxylic acids include phthalic acid, isophthalic acid, 1,4-, 1,5-, 2,6- or 2,7-naphthalenedicarboxylic acid, 1,3- or 1,4-cyclohexanedicarboxylic acid (which may be cis, trans or a mixture thereof), cyclohexanediacetic acid, trans-4,4′stilbenedicarboxylic acid, 4,4′-oxydibenzoic acid, 3,3′- and 4,4′-biphenyldicarboxylic acids and aliphatic dicarboxylic acids such as malonic, succinic, glutaric, adipic, pimelic, suberic, azelaic, sebacic, nonane, decane, and dodecanedicarboxylic acids. The diacid residues comprising the diester may be derived from the dicarboxylic acid, dialkyl esters thereof, e.g., dimethyl terephthalate and bis(2-hydroxyethyl) terephthalate, acid chlorides thereof and, in some cases, anhydrides thereof.

The diol component of the copolyesters comprises from 98 to 1 mole percent ethylene glycol residues and 2 to 99 mol percent 1,3-cyclohexanedimethanol and/or 1,4-cyclohexanedimethanol. Up to 20 mole percent of the diol component may be made up of the residues of one or more diols other than ethylene glycol and cyclohexanedimethanol such that the sum of all diol residues is 100 mole percent. Examples of such additional diols include cycloaliphatic diols having 3 to 16 carbon atoms and aliphatic diols having 3 to 12 carbon atoms. Specific examples of such other diols include 1,2-propanediol, 1,3-propanediol, neopentyl glycol, 1,4-butanediol, 1,5-pentanediol, 1,6-hexanediol, 2,2,4,4-tetramethyl-1,3-cyclobutanediol (trans-, cis- or mixtures thereof), and p-xylylene glycol. The copolyesters also may be modified with minor amounts of polyethylene glycols or polytetramethylene glycols to enhance elastomeric behavior, e.g., polyethylene glycols and polytetramethylene glycols having weight average molecular weights in the range of about 500 to 2000. The diol component of the copolyesters preferably consists essentially of residues of ethylene glycol and 1,4-cyclohexanedimethanol. Preferably the diol component is from 67 to 75 mole % ethylene glycol and from 33 to 25 mole % 1,4-cyclohexanedimethanol.

The copolyesters useful in the present invention may be prepared by conventional polycondensation procedures well-known in the art. Such processes include direct condensation of the dicarboxylic acid(s) with the diols or by ester interchange using a dialkyl or diaryl dicarboxylate. For example, a dialkyl terephthalate, e.g., dimethyl terephthalate or bis(2-hydroxyethyl) terephthalate, or a diaryl ester such as diphenyl terephthalate is ester interchanged with the diols at elevated temperatures in the presence of a polycondensation catalyst.

The copolyesters have an inherent viscosity in the range of 0.5 to 1.2 dL/g when measured at 25° C. using 0.50 grams of polymer per 100 ml of a solvent which consists of 60% by weight phenol and 40% by weight tetrachloroethane. The copolyesters utilized in the thermoplastic article of the present invention preferably have an inherent viscosity of 0.6 to 0.9 dL/g (measured as described herein) and, most preferably, consist of terephthalic acid residues, ethylene glycol residues, and 1,4-cyclohexanedimethanol residues.

When the first thermoplastic layer 12 is a polycarbonate, the bis-phenol A derived material can be modified with a number of materials that are included to enhance the performance of the polycarbonate such as the above described polyester, tetrabromo bis-phenol A for flame retardancy, and acrylonitrile-butadiene-styrene (ABS) elastomeric modifiers.

The second thermoplastic layer 18 of the laminate 10 is a woven or non-woven polyolefinic fabric. The polyolefin may be a polyolefin resin, blend or copolymer derived from ethylene polymerized with at least one other comonomer, such as for example straight, or branched C₃-C₂₀ alkene. Preferably, the second thermoplastic layer 18 is a woven fabric composed substantially of polyethylene or propylene fibers having a thickness of from about 0.001 mm to about 10 mm, preferably from about 0.01 mm to about 5 mm and most preferably from about 0.2 to about 3 mm. The fibrous component may be in any convenient form, e.g. as individual fibers, filaments, fiber bundles or non-woven, woven or knitted fabric. The term “fibers” is used for convenience herein and is intended that the term embrace both staple fibers as well as continuous filament, cut to desired length, bundles thereof or fabrics based thereon. Preferably, the woven fabric is composed of polyethylene fibers. The polyethylene comprising the fibers can be composed of low, medium, or high density polyethylene typically having a density ranging from about 0.86 g/cm³ to about 1.05 g/cm³ and a molecular weight of from about 3000 to 100,000, and preferably from about 5,000 to 50,000, including metallocene catalyst prepared polyethylene.

Desirably, the fabric composing the second thermoplastic layer 18 is made by weaving or knitting threads or yarns of the fibers together. Preferably, the woven polyethylene fabric is composed of yarns that are in a tape form and are UV radiation resistant. Such fabrics are commercially available from Carnegie Fabrics under the trade name XOREL. The fabric may display images or decorative designs produced in the fabric by using well known weaving or knitting techniques.

Optionally, the woven polyethylene fabric can include from 0% to 90% bicomponent fibers wherein at least a portion of the fiber is polyethylene. The bicomponent fibers can be of any suitable configuration as long as a substantial portion of the fiber's polyethylene component, i.e., greater than 30% of the fabric surface area, and preferably greater than 50% of the fabric surface area, is adjacent to the first thermoplastic layer 12 when laminated. Alternatively, the bicomponent fiber can have a sheath and a core, wherein the sheath is a polyolefinic material selected from polyethylene and polypropylene and preferably is polyethylene. Typically, in such heterofilaments as the sheath/core fibers above, the sheath material differs from the core material. The difference may arise not only from their respective chemical compositions but may also arise from the physical properties of the materials.

The thickness of the polyolefin fabric layer 18 is not critical to the invention and is limited only by functionality. Generally, the thickness of the polyolefin fabric may range from about 0.001 inch to about 0.010 inch (0.025 mm to about 0.254 mm) in thickness, and more preferably from 0.001 inch to 0.007 inch (0.025 mm to 0.178 mm).

Applied to at least one of the surfaces 14, 16, or 20 is a bonding agent 22. Since the first thermoplastic layer 12 is generally more substantial and rigid as compared to the second thermoplastic layer 18, it is preferred to apply the bonding agent 22 to the first surface 14 of the first thermoplastic layer 12. After the bonding agent cools, the second thermoplastic layer 18 is superposed over and applied to the first surface 14. However, it is within the scope of the invention to apply the bonding agent to the third surface 20 of the second thermoplastic layer.

The bonding agent 22 is selected to have Theological properties enabling the bonding agent to be applied initially in a random or uniform pattern so that the bonding agent disposed between the layers is substantially discontinuous pattern along the width or X direction and along the length or Y direction. Preferably, the bonding agent 22 is applied in a discontinuous pattern in both the X and Y directions, providing relatively small spaces of discontinuity in the bonding agent layer. The bonding agent 22 may be a sheet or liquid applied to the surface by spraying, sputtering, or dripping the bonding agent in drops or strings from a crosswise disposed drip tube with a plurality of small spaced-apart openings. The bonding agent 22 is preferably permitted to dry before the second thermoplastic layer is placed in a superposed relationship with the third surface 20 proximate to the bonding agent 22 layer.

Suitable bonding agents for use in the present invention include waterborne polyurethane which is liquid at 23° C. (available from Hauthaway under the trademark HD 2001), polyethylene film available from SARAXIRO, Germany, vinyl alcohol adhesives, acrylic adhesives, epoxy adhesives, and combinations thereof. The bonding agent may be applied between any layers of the synthetic laminate structure.

To improve the adhesion of the bonding agent 22 to the third surface 20 of the second thermoplastic layer 18 it may be necessary to treat the surface, or bulk, of the polyolefin. Treatment may be accomplished with any of several methods known in the industry. For example, the surface of the polyolefin may be contacted with a non-neutral solution adequate to modify the fiber surface prior to contacting the fiber with the bonding agent. Generally, non-neutral solution can have a pH greater than 7 and may include from about 0.01 weight percent to about 4 weight percent caustic. The fiber may also be treated using a combination of basic and acidic solutions wherein the fiber is contacted with a solution having a pH greater than 7 which is subsequently neutralized, if needed, using an appropriate acidic solution having a pH less than 7. This caustic/acid neutralization step may also include at least partially drying the fiber.

Alternatively, the surface may be prepared using a primer type of coating. Preferably, the polyolefin fiber has at least of portion of the surface subjected to corona treatment from an electrical discharge in air or another atmosphere, or by flame treatment to improve the bonding between the dissimilar surfaces.

Referring to FIG. 2, a second embodiment of a laminated article 50 is illustrated having a construction similar, in part, to that described above. More particularly, the laminated article has a first thermoplastic layer 12 with a first surface 14 and second surface 16. Positioned proximate to the first surface 14 is a second thermoplastic layer 18. The second thermoplastic layer includes a third surface 20 juxtaposed to at least one of the first or second surfaces, and preferably adjacent to the first surface 14. Disposed between the first surface 14 and the third surface 20 is a bonding agent 22. The laminated article 50 further includes a third thermoplastic layer 52 having a fourth surface 54 generally disposed adjacent to the second surface 16. Disposed between the second surface 16 and the fourth surface 54 is second layer of the bonding agent 22a.

Desirably, the third thermoplastic layer 52 is a woven or non-woven polyolefinic fabric similar to the second thermoplastic layer 18 described above. Preferably, the third thermoplastic layer 52 is a woven fabric composed substantially of polyethylene or propylene fibers having a density of from about 0.91 g/cm³ to about 0.98 g/cm³.

With reference to FIG. 1, the method for preparing the thermoplastic laminate article of the present invention involves coating or applying the bonding agent 22 in a random or uniform pattern on at least one of the first surface 14 and/or the third surface 20 so that a substantially discontinuous layer of the bonding agent 22 is between the first thermoplastic layer 12 and second thermoplastic layer 18; placing the first thermoplastic layer 12 and the second thermoplastic layer 18 in a superposed relationship over the at least one coated surface to form a substantially stacked configuration; and applying sufficient heat and pressure to outer surfaces 24 and 26 of the stacked or layered configuration to cause the bonding agent 22 to flow and spread between the first surface 14 and third surface 20 to form a substantially continuous layer and to form a bond between the first thermoplastic layer 12 and the second thermoplastic layer 18.

The bonding agent 22 may be applied to the surface by spraying the bonding agent in a liquid form such as sputtering, or dripping the bonding agent in drops or strings from a crosswise disposed drip tube with a plurality of small spaced-apart openings.

In bonding the first thermoplastic layer and second thermoplastic layer together, heat and pressure is applied to the outer surfaces 24 and 26 to cause the bonding agent layer to flow and spread between the first and third surfaces 14 and 20 into a substantially continuous layer, providing an effective bond between the first and second thermal layers 12 and 18 and desirably, is characterized by a substantial absence of visible air pockets or adhesion discontinuities. The bonding agent initially separates the first thermoplastic layer and second thermoplastic layer in a discontinuous manner with a deliberate pattern of spaces between the layers until sufficient heat and pressure is applied to cause the material to flow and spread into a substantially uniform and continuous layer mechanically and gradually squeezing air from between the outer layer and the adjacent layer, thus minimizing or eliminating formation of air pockets or interface discontinuities.

The laminating method includes using hot press bonding and cold press bonding. Lamination should be conducted at a temperature and pressure sufficient to cause the bonding agent layer to become tacky and bond to the first thermoplastic layer and second thermoplastic layer without causing decomposition, distortion, or other undesirable effects. Hot press bonding is typically conducted at a temperature of about greater than about 150° F. (65.5° C.). Desirably, hot press bonding is conducted at a temperature of from about 175° F. to about 340° F., (80° C. to about 171° C.), preferably 200° F. to 255° F., (93° C. to 124° C.), a pressure of 40 psi to 110 psi, (2.81 kg/cm² to 7.73 kg/cm²), preferably 90 psi to 100 psi, (6.33 kg/cm² to 7.03 kg/cm²) and for a period of time of about 1 to about 15 minutes, preferably 7 to 13 minutes or until the material obtains a surface temperature of about 210° F. to 230° F. (99° C. to 110° C.).

Following the hot press bonding the laminated article is subjected to cold press bonding wherein the laminate structure is held rigid at a temperature of about 70° F. to about 340° F., (21° C. to about 171° C.), preferably 100° F. to 130° F. (37.7° C. to 54.4° C.) and a pressure of about 13 psi to about 500 psi, (0.9 kg/cm² to about 35.1 kg/cm²), preferably 100 psi to 300 psi, (7.03 kg/cm² to 21.09 kg/cm²) more preferably from 100 psi to 250 psi (7.03 kg/cm² to 17.57 kg/cm²) while the laminate structure cools.

Lamination may be conducted using individual relatively short sheets of overlaid material or using elongated sheets for later width wise separation. The material is preferably laminated in a stationary press, however, the material may be laminated using continuous casting equipment of the type used in the plastics industry for producing laminate web material such as a machine employing upper and lower continuous belts. At least one of the belts is generally heated and the laminate structure is fed into the space between the belts for movement with the belts while being heated and pressed.

In a preferred embodiment, during the hot press and cold press bonding the second thermoplastic layer 18 is substantially fixedly held or restrained by a retaining means to prevent the polyolefin fabric from appreciably shrinking and affecting the construction or appearance of the laminated article. Suitable retaining means include a tenter frame wherein the edges of the polyolefin fabric are fixedly held and the polyolefin fabric is superposed position over the first thermoplastic layer until the laminate article has cooled sufficiently to prevent the second thermoplastic layer from shrinking. As used herein, “substantially fixedly held or restrained” means that the second thermoplastic layer 18 is sufficiently restrained so that shrinkage of the fabric along the length or width is less than about 25%, and preferably less than about 15% and more preferably less than about 10%.

In a more preferred embodiment, the retaining means is a metal plate having a thickness of from about 0.125 to 0.375 of an inch (3.2 mm to 9.6 mm) wherein the polyolefin fabric wraps the metal plate and the exposed edges of the polyolefin fabric are substantially aligned and affixed together so that the fabric is substantially fixedly restrained. The edges of the polyolefin fabric extend beyond the edge of the metal plate may be secured by sewing, stapling, gluing, or melt bonding using a heated wire element or ultrasonic bonding apparatus.

In laminating the layers together, a metal plate, such as a steel or aluminum plate, a pressure pad, which is preferably a compressible fabric pad to help equalize pressure, and a further metal plate, which is preferably a flexible aluminum plate having a thickness of 20 mills to 140 mills, are respectively aligned in a parallel pressing relation upon the exterior surface of the first thermoplastic layer and second thermoplastic layer. The fabric pad is preferably prepared from copper, silicone, NOMEX which is an aramid fiber or fabric available from DuPont de Nemours, E.I. & Company, or a combination of copper and/or silicone and/or NOMEX.

Preferably, a cast paper or embossing paper may be disposed between the metal plate and an exterior surface 26 of the first thermoplastic layer to provide a texture to the laminate structure and/or to prevent the outer layer which is comprised of PETG copolyester from sticking to the metal plate. Examples of cast paper or embossing paper include patent paper which provides a high gloss, patina which provides a satin finish, matte, stucco, ostrich, reptilian, glitter, topaz, grid, and allegro which provides a leather appearance.

Once the laminated article has cooled it may be thermoformed into a variety of useful articles. Illustrative articles include wall partitions, counter tops, table tops, cabinet doors, juvenile products, indoor and outdoor signs, and other articles where it is desirable to have an exposed textured surface.

Alternatively, the laminated article 10 can have a three dimensional pattern provided on the first thermoplastic layer and second thermoplastic layers, such as for example, an undulating design on the outer surfaces 24 and 26. Such patterns may be formed on the first and second thermoplastic layers either during hot press bonding or in a separate process wherein the thermoplastic laminate article of the present invention is heated sufficiently to be thermoformed to the desired pattern, shape or configuration.

### EXAMPLE

With reference to FIGS. 1 and 3, the method for preparing the thermoplastic laminate article 10 of the present invention involves preparing a layered construction 60. For ease of description, the illustrated layered construction 66 is one-half of a typical “sandwich” configuration with that portion not illustrated being a mirror image, as viewed from the base or metal plate 62, of the illustrated drawing.

A sandwich type configuration is prepared by placing a first layer of paper 64 (available from Sappi, Cumberland, Me.) adjacent to the surfaces of the metal plate 62. The polyethylene fabric 18 had one surface subjected to corona discharge for a time sufficient to raise the surface energy or surface tension sufficiently for the adhesive to adhere to the polyethylene fabric. With the corona treated side of the fabric 18 disposed away from the first layer of paper 64, the polyethylene fabric was wrapped around the first layer of paper 64 and the metal plate 62. The free edges of the fabric 18 were affixed together by stitching so as to completely enclose the first layer of paper 64 and the metal plate 62.

A layer of polyethylene adhesive or bonding agent 22 having a thickness of about 0.001 of an inch (0.0254 mm) was applied to one surface 14 of the polyester 12 (available from Eastman Chemical Company, Kingsport, Tenn.). This polyester/adhesive combination was then superposed over the corona treated surface of the fabric 18. In finishing the sandwich construction, a second paper layer 66 was placed over the second polyester surface, a second metal plate 68 was placed on top of the second paper layer 66, and finally a pressure pad 70 was placed on top of the second metal plate 68, wherein all the layers were in a substantially superposed configuration.

The layered construction 60 was then subjected to hot press bonding at a temperature of about 190° F. to 230° F. for about 10 minutes. The layered construction 60 was then subjected to ambient temperature cold press bonding until the layered construction 60 cooled sufficiently for the adhesive to set and affix the polyethylene fabric to the polyester layer.

Having described the invention in detail, those skilled in the art will appreciate that modifications may be made to the various aspects of the invention without departing from the scope and spirit of the invention disclosed and described herein. It is, therefore, not intended that the scope of the invention be limited to the specific embodiments illustrated and described but rather it is intended that the scope of the present invention be determined by the appended claims and their equivalents. Moreover, all patents, patent applications, publications, and literature references presented herein are incorporated by reference in their entirety for any disclosure pertinent to the practice of this invention.

I claim:

1. A thermoplastic laminated article comprising:
a. a first thermoplastic layer selected from the group consisting of polyester and polycarbonate and having first and second surfaces;
b. a second thermoplastic layer selected from the group consisting of polyethylene and polypropylene and having a third surface disposed toward said first surface; and
c. a bonding agent disposed between said first and third surfaces for securing said first thermoplastic layer and said second thermoplastic layer.

2. The thermoplastic laminated article of claim 1 wherein said first thermoplastic layer has a thickness of from about 0.127 mm to about 24.1 mm.

3. The thermoplastic laminated article of claim 2 wherein said polyester has an inherent viscosity of from about 0.5 to about 1.2 dL/g.

4. The thermoplastic laminated article of claim 3 wherein said polyester has a diol component comprising from 67 to 75 mole % ethylene glycol and from 33 to 25 mole % 1,4-cyclohexanedimethanol.

5. The thermoplastic laminated article of claim 1 wherein said second layer is polyethylene.

6. The thermoplastic laminated article of claim 5 wherein said second thermoplastic layer is a thermoplastic fabric composed of polyethylene fibers having a thickness of from about 0.001 mm to about 10 mm.

7. The thermoplastic laminated article of claim 6 wherein said polyethylene fibers have a thickness of from about 0.01 mm to about 5 mm.

8. The thermoplastic laminated article of claim 6 wherein said polyethylene fibers have a thickness of from about 0.2 mm to about 3 mm.

9. The thermoplastic laminated article of claim 6 wherein said polyethylene has a density of from about 0.86 g/cm³ to about 1.05 g/cm³.

10. The thermoplastic laminated article of claim 6 wherein said thermoplastic fabric is a woven fabric.

11. The thermoplastic laminated article of claim 6 wherein said thermoplastic fabric is a non-woven fabric.

12. The thermoplastic laminated article of claim 6 wherein said fabric further comprises bicomponent fibers having a sheath and core configuration, and wherein said sheath is a polyolefinic material selected from polyethylene and polypropylene.

13. The thermoplastic laminated article of claim 1 wherein said first layer is a polyester and said second layer is a woven polyethylene fabric composed of polyethylene fibers having a thickness of from about 0.2 to about 3 mm.

14. The thermoplastic laminated article of claim 1 further comprising:
d. a third thermoplastic layer having a fourth surface disposed toward said second surface; and
e. a second bonding agent disposed between said second and fourth surfaces for securing said first thermoplastic layer and said third thermoplastic layer.

15. The thermoplastic laminated article of claim 1 wherein said bonding agent is an adhesive selected from the group consisting of polyurethanes, polyethylene, vinyl alcohols, acrylics and mixtures thereof.

16. A thermoplastic laminated article comprising:
a. a first thermoplastic layer having a first and second surfaces;
b. a second thermoplastic layer having a third surface disposed toward said first surface; and
c. a bonding agent disposed between said first and third surfaces for securing said first thermoplastic layer and said second thermoplastic layer, wherein said first thermoplastic layer is a polyester having an inherent viscosity of from about 0.5 to about 1.2 dL/g and said second thermoplastic layer is a polyolefinic material selected from polyethylene and polypropylene.

17. The thermoplastic laminated article of claim 16 wherein said polyester has a diol component comprising from 67 to 75 mole % ethylene glycol and from 33 to 25 mole % 1,4-cyclohexanedimethanol.

18. The thermoplastic laminated article of claim 16 wherein said second thermoplastic layer is a woven thermoplastic fabric composed of polyethylene fibers having a thickness of from about 0.2 to about 3 mm and a density of from about 0.86 g/cm³ to about 1.05 g/cm³.

19. The thermoplastic laminated article of claim 16 wherein said fabric further comprises bicomponent fibers having a sheath and core configuration, and wherein said sheath is polyethylene having a density of from about 0.86 g/cm³ to about 1.05 g/cm³.

20. A method for making thermoplastic laminated article comprising the steps of:
a. providing a thermoplastic first layer having first and second surfaces, and a second thermoplastic layer having a third surface disposed toward said first surface;
b. applying a bonding agent onto at least one of said first or third surfaces;
c. placing the first thermoplastic layer and second thermoplastic layer in a superposed relationship with said bonding agent between said layers; and
d. applying sufficient heat and pressure to said second surface and an outer surface of said second thermoplastic layer to cause the bonding agent to flow and spread between said first and third surfaces to form a substantially continuous layer and to form a bond between said first thermoplastic layer and said second thermoplastic layer.

21. The method of claim 20 wherein step (c) includes hot press bonding conducted at a temperature of about 175° F. to about 340° F., (80° C. to about 171° C.), and a pressure of 40 psi to 110 psi (2.81 kg/cm² to 7.73 kg/cm²), followed by cold press bonding conducted at a temperature of about 70° F. to about 340° F. (21° C. to about 171° C.), and a pressure of about 13 psi to about 500 psi (0.9 kg/cm² to about 35.1 kg/cm²).

22. The method of claim 19 wherein said hot press bonding is conducted at a temperature of about 200° F. to 255° F., (93° C. to 124° C.), and a pressure of 90 psi to 100 psi (6.33 kg/cm² to 7.03 kg/cm²), and said cold press bonding is conducted at a temperature of about 100° F. to about 130° F. (37.7° C. to 54.4° C.), and a pressure of about 100 psi to about 250 psi (7.03 kg/cm² to 17.57 kg/cm²).

23. The method of claim 20 further comprising securing said second thermoplastic layer in a retaining means to prevent the second thermoplastic layer from shrinking during hot press bonding.

24. A method for making thermoplastic laminated article comprising the steps of:
a. providing a polyester first layer having first and second surfaces;
b. applying a bonding agent to said first surface;
c. providing a polyolefin second layer in a superposed relationship with said first layer, wherein said polyolefin second layer has a third surface disposed toward said first surface, and wherein said polyolefin second layer is substantially fixedly restrained by a retaining means;
d. applying sufficient heat and pressure to said second surface and an outer surface of said polyolefin second layer to cause the bonding agent to flow and spread between said first and third surfaces to form a substantially continuous layer and to form a bond between said first thermoplastic layer and said second thermoplastic layer.

25. The method of claim 24 wherein said retaining means comprises a metal plate and said second layer wraps said metal plate and exposed edges of the polyolefin fabric are substantially aligned and affixed together.

26. The method of claim 24 wherein said retaining means comprises a tenter frame.

27. The method of claim 25 further comprises providing a paper layer adjacent to a surface of said metal plate, a second paper layer adjacent to said second surface, a second metal plate adjacent to said second paper layer and a pressure pad adjacent to said second metal plate, wherein said paper layers, second metal plate and pressure pad are in a substantially superposed layered configuration.

28. The method of claim 27 wherein step (d) includes hot press bonding conducted at a temperature of about 175° F. to about 340° F., (80° C. to about 171° C.), and a pressure of 40 psi to 110 psi (2.81 kg/cm² to 7.73 kg/cm²), followed by cold press bonding conducted at a temperature of about 70° F. to about 340° F. (21° C. to about 171° C.), and a pressure of about 13 psi to about 500 psi (0.9 kg/cm² to about 35.1 kg/cm²).

29. The method of claim 27 wherein said polyolefin fabric is a woven polyethylene fabric composed of polyethylene fibers having a thickness of from about 0.2 to about 3 mm and a density of from about 0.86 g/cm³ to about 1.05 g/cm³.

30. The method of claim 27 wherein prior to step (d) said third surface is corona treated.
